(19) United States
(12) Patent Application Publication
(10) Pub. No.: US 2005/0258650 A1
(43) Pub. Date: Nov. 24, 2005

(54) Threaded pressure fitting with recessed thread roots

(76) Inventor: Douglas Swingley, Saugus, CA (US)

Correspondence Address: SHELDON & MAK, INC, 225 SOUTH LAKE AVENUE, 9TH FLOOR, PASADENA, CA, 91101, US

(21) Appl. No.: 11/124,250

(22) Filed: May 6, 2005

Related U.S. Application Data
(63) Continuation-in-part of application No. 10/768,417, filed on Jan. 28, 2004, now abandoned.

(51) Int. Cl. F16L 25/00

(52) U.S. Cl. 285/390

(57) ABSTRACT

A pressure fitting has a body with an internal bore of a specific nominal diameter. The internal bore is threaded with internal bore threads. The internal bore threads have sides, crests and roots. The sides are disposed at a specific angle φ. The roots are recessed such that, when an externally threaded pipe having (i) the same nominal diameter as the bore of the pressure fitting body, and (ii) external threads with sides disposed at the same specific angle φ and with sharp crests is disposed within the bore of the pressure fitting body, the sharp crests of the external threads do not impinge upon the roots of the internal threads.

### RELATED APPLICATION

This application is a continuation-in-part application of U.S. patent application Ser. No. 10/768,417, filed Jan. 28, 2004, entitled THREADED PIPE FITTING WITH RECESSED THREAD ROOTS, the entirety of which is incorporated herein by this reference.

### FIELD OF THE INVENTION

This invention relates generally to pipe fittings and, more specifically, to threaded pressure fittings, i.e., threaded pipe fittings adapted to carry fluids at elevated pressures.

### BACKGROUND OF THE INVENTION

A common problem with the use of threaded pressure fittings, especially with non-metallic female threaded pressure fittings, is cracking which originates in the threads. A common cause of such cracking is the impingement of the crests of male threaded fittings with the roots of the female threaded fitting.

In the prior art, the impingement of crests and roots have attempted to be minimized by truncating the crests on the threads of the male pressure fitting and by providing a female pressure fitting with rounded off roots. The theory for this is that any infringement of the non-sharp crests and roots would cause minimized stress in the roots—and therefore less cracking. This technique has not proved reliable. Externally threaded male fittings marketed as having truncated crests frequently have crests which have insufficient or non-existent truncations.

Accordingly, there is a need for pressure fittings which avoid the aforementioned problem in the prior art.

### SUMMARY

The invention satisfies this need. The invention is a pressure fitting for carrying a fluid at a chosen elevated pressure, typically greater than about 25 psig, and often higher, such as within pressure ranges of between about 50 psig and about 850 psig or between about 225 psig and about 850 psig. The pressure fitting has a body with an internal bore with a specific nominal diameter. The internal bore is threaded with internal bore threads. The internal bore threads have sides, crests and roots. The sides are disposed at a specific angle φ. The roots are recessed such that, when an externally threaded pipe having (i) the same nominal diameter as the bore of the pressure fitting body, and (ii) external threads with sides disposed at the same specific angle φ and with sharp crests is disposed within the bore of the pressure fitting body, there is a clearance between the sharp crests of the external threads and the roots of the internal threads such that the sharp crests do not impinge upon the roots. The clearance is chosen so as to be sufficiently small to provide leak-free service when the pressure fitting is carrying a fluid at the chosen elevated pressure.

### DRAWINGS

These and other features, aspects and advantages of the present invention will become better understood with reference to the following description, appended claims and accompanying drawings where:

FIG. 1 is a perspective view of a female pressure fitting having features of the invention;

FIG. 2 is a cross-sectional view of the pressure fitting illustrated in FIG. 1;

FIG. 3 is a detailed view of threads of pressure fittings in the prior art;

FIG. 4 is a detailed view of pipe threads having features of the invention;

FIG. 5 is a further detailed view of a single pipe thread root having features of the invention; and

FIG. 6 is a second detailed view of a pipe thread root having features of the invention.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a pressure fitting 10 having a body 12 and an internal bore 14 of a specific nominal diameter. The internal bore 14 is threaded with internal bore threads 16. The internal bore threads 16 have sides 18, crests 20 and roots 22. The sides 16 are disposed at a specific angle φ.

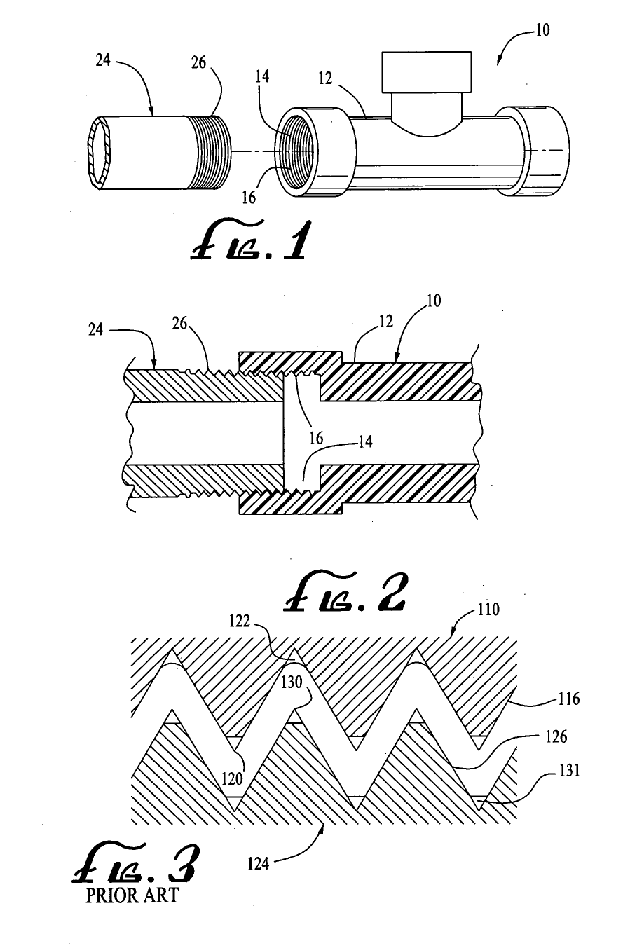

FIG. 1 illustrates the internally threaded pressure fitting 10 as it would be mated to an externally threaded pipe 24.

FIG. 2 is a cross sectional diagram illustrating how the internally threaded pressure fitting 10 can be mated with the externally threaded pipe 24.

FIG. 3 is a diagrammatic detail illustration of the internal threads 116 of an internally threaded pressure fitting 110 of the prior art showing it mated with the external threads of an externally threaded pipe 124. As can be seen in FIG. 3, prior art threads 116 and 126 can have sharp crests 120 and 130 and roots 122 and 131 or slightly truncated crests 120 and 130 and roots 122 and 131.

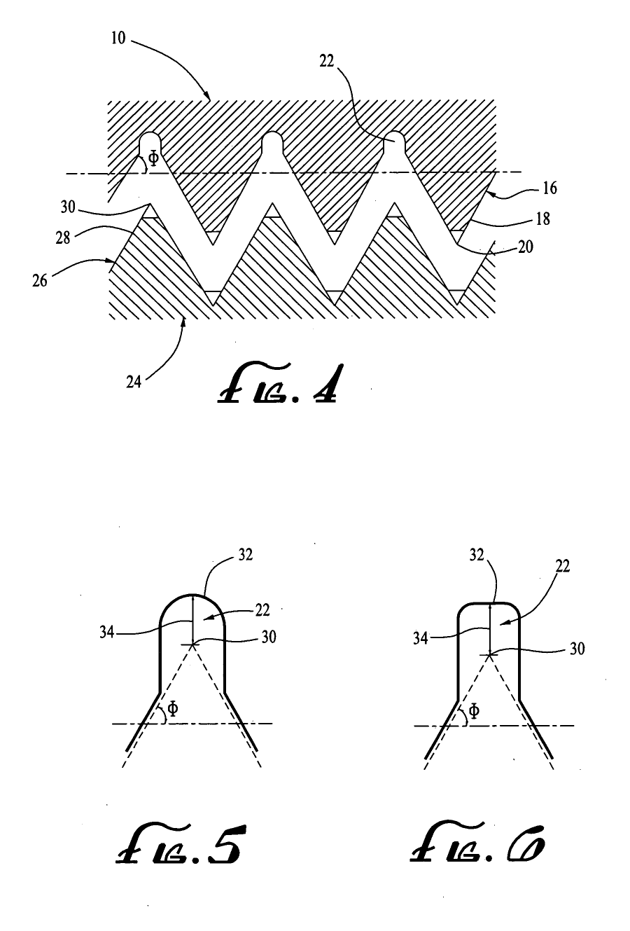

FIG. 4 illustrates one embodiment of the invention wherein the roots 22 of the internally threaded pressure fitting 10 are recessed such that, when an externally threaded pipe 24 having (i) the same nominal diameter as the bore 14 of the pressure fitting 10, and (ii) external threads 26 with sides 28 disposed at the same specific angle φ and with sharp crests 30 is disposed within the bore 14 of the pressure fitting 10, the sharp crests 30 of the external threads 26 do not impinge upon the roots 22 of the internal threads 16. By this design, it is impossible for the crests 30 of the externally threaded pipe 24 to impinge upon the roots of the internally threaded pressure fitting 10, even if the crests 30 of the externally threaded pipe 24 are sharp. This is illustrated in FIGS. 5 and 6. FIG. 5 illustrates one embodiment of the invention wherein each of the roots 22 of the internally threaded pressure fitting 10 has a base 32 which is rounded. FIG. 6 illustrates another embodiment of the invention wherein each of the roots 22 of the internally threaded pressure fitting 10 has a base 32 which is generally flat.

The clearance between the roots 22 of the internally threaded pressure fitting 10 and the sharp crests 30 of an externally threaded pipe 24 disposed within the bore 14 is chosen so that the pressure fitting 10 does not leak for the service and pressure for which it is designed. Typically, the clearance 24 between the roots 22 and the sharp crests 30 is less than about 0.03 inches in depth. It has been found that this clearance provides a leak-free pressure fitting even to pressures of 850 psig. Greater clearances can also be used, but tend to allow some degree of leakage in many services and operating pressures.

Because of the recessed roots of the invention, and the impossibility of impingement against the roots, stress induced cracks caused by impingement against the roots is eliminated.

It was previously believed by those of skill in the art that pressure fittings of the type illustrated in FIG. 3 were a necessity to prevent leakage at elevated pressures. Surprisingly, it has been found that pressure fittings of the invention, such as those illustrated in FIG. 4, can be made to provide leak-free service, even to pressures as high as 850 psig, by merely coating the pressure fitting 10 with a small amount of an ordinary pipe sealing compound, such as pipe sealing compounds commonly used with pressure fittings 110 of the prior art. Such pipe sealing compounds typically are viscous mixtures of (i) a fluid, such as alcohol, ethylene glycol, fish oil, vegetable oil and/or petroleum distillates, and (ii) suspended compressible packing particles, such as fumed silica, cellulose, clay, Teflon® and/or metals.

Having thus described the invention, it should be apparent that numerous structural modifications and adaptations may be resorted to without departing from the scope and fair meaning of the instant invention as set forth hereinabove.

1. A pressure fitting for carrying a fluid at a chosen elevated pressure, the pressure fitting having a body with an internal bore of a specific nominal diameter, the internal bore being threaded with internal bore threads, the internal bore threads having sides, crests and roots, the sides being disposed at a specific angle φ, the roots being recessed such that, when an externally threaded pipe having (i) the same nominal diameter as the bore of the pressure fitting body, and (ii) external threads with sides disposed at the same specific angle φ and with sharp crests is disposed within the bore of the pressure fitting body, there is a clearance between the sharp crests of the external threads and the roots of the internal threads such that the sharp crests do not impinge upon the roots, the clearance being sufficiently small to provide leak-free service when the pressure fitting is carrying a fluid at the chosen elevated pressure.

2. The pressure fitting of claim 1 wherein the roots each have a base which is rounded.

3. The pressure fitting of claim 1 wherein the roots each have a base which is generally flat.

4. The pressure fitting of claim 1 wherein, when an externally threaded pipe having (i) the same nominal diameter as the bore of the pressure fitting body, and (ii) external threads with sides disposed at the same specific angle φ and with sharp crests is disposed within the bore of the pressure fitting, a clearance is defined between each sharp crest of the externally threaded pipe and one of the roots of the pressure fitting which is less than about 0.03 inches in depth.

5. The pressure fitting of claim 1 wherein the chosen elevated pressure is in excess of 25 psig.

6. The pressure fitting of claim 1 wherein the chosen elevated pressure is between about 50 psig and about 850 psig.

7. The pressure fitting of claim 1 wherein the chosen elevated pressure is between about 225 psig and about 850 psig.
